(19) United States
(12) Patent Application Publication
(10) Pub. No.: US 2020/0255642 A1
(43) Pub. Date: Aug. 13, 2020

(54) STABILIZED FIBER-CONTAINING COMPOSITE

(71) Applicant: Fibre Reinforced Thermoplastics B.V., Lelystad (NL)

(72) Inventor: Joris WISMANS, Lelystad (NL)

(21) Appl. No.: 16/651,723

(22) PCT Filed: Sep. 26, 2018
(86) PCT No.: PCT/IB2018/057463

§ 371 Date: Mar. 27, 2020

Related U.S. Application Data
(60) Provisional application No. 62/564,571, filed on Sep. 28, 2017.

(51) Int. Cl. C08L 23/12; C08J 5/04; C08K 5/098; C08K 7/14

(52) U.S. Cl. CPC C08L 23/12; C08J 5/043; C08K 2201/019; C08K 7/14; C08J 2323/12; C08K 5/098

(57) ABSTRACT

Fiber-containing composites that include non-metal oxide acid scavengers, methods of making fiber-containing composites, and uses thereof are described. A fiber-containing composite can include a polymer matrix and fibers. The polymer matrix can include at least one non-metal oxide acid scavenger, a thermoplastic polymer, optionally carbon black, antioxidants, light stabilizers, heat stabilizers, or combinations thereof.

### CROSS REFERENCE TO RELATED APPLICATIONS

This application claims the benefit of priority of U.S. Provisional Patent Application No. 62/564,571 filed Sep. 28, 2017, which is hereby incorporated by reference in its entirety.

### BACKGROUND OF THE INVENTION

### A. Field of the Invention

The invention generally concerns stabilized fiber-containing composites. In particular, a stabilized fiber-containing composite of the invention can include at least one non-metal oxide containing acid scavenger and can have an increased tensile strength when compared to the same composite that includes a metal-oxide (e.g., zinc-oxide) containing acid scavenger rather than the non-metal oxide containing acid scavenger.

### B. Description of Related Art

Thermoplastic composites can be used to form structures having advantageous structural characteristics, such as high strength, high stiffness, and/or relatively low weight when compared to similar structures formed from conventional materials. As a result, thermoplastic composites are used in a variety of applications across a wide range of industries, including, for example, the automotive, aerospace, vessels, thermoplastic reinforced pipes, and consumer electronics industries.

Some composites can include fibers, which can be made by impregnating a tow of fibers with a thermoplastic matrix material. In traditional impregnation techniques, a relatively high viscosity matrix material is forced through a dry and relatively low permeability tow of fibers. As a result, traditional impregnation techniques can produce fiber reinforced materials that have relatively low and/or unpredictable fiber volume fractions, relatively uneven distributions of fibers within the materials, excesses of matrix material, and/or the like. This can result in fiber reinforced composites having undesirable and/or unpredictable structural characteristics. By way of example, International Patent Application Nos. WO2016142781, WO2016142784, and WO2016142784 to Prins et al. describe unidirectional tapes and methods of making said tapes.

During processing, thermoplastic composites can be exposed during conversion (some are open processes, which means exposure to air) to multiple heat cycles before being used in the final applications. In addition, during the life time of the thermoplastic composite, the article of manufacture that includes the thermoplastic composite can be exposed to environmental conditions, such as high temperature, (UV) light, moisture, etc. These conversion and exposure conditions can cause degradation of the thermoplastic matrix, thereby further compromising the structural integrity of the composite. One solution to address this matrix degradation issue has been to incorporate stabilizers into the polymeric matrix to help stabilize the matrix by preventing or reducing matrix degradation. For example, metal oxides such as zinc oxide have been used as acid scavengers to help prevent or reduce matrix degradation caused by acids present within the matrix.

While various attempts have been made to produce thermoplastic composites with thermal and environmental stability, addition of stabilizers such as metal oxides (e.g., zinc oxide) to the thermoplastic matrix can be detrimental to the mechanical properties of the resulting thermoplastic composite.

### SUMMARY OF THE INVENTION

A discovery has been made that addresses at least some of the problems associated with fiber-containing thermoplastic composites. The discovery is premised on using a non-metal oxide containing acid scavenger in the thermoplastic polymer matrix of the fiber-containing composite. As exemplified in the Examples, it was surprisingly found that metal oxide containing acid scavengers such as zinc oxide can damage the structural integrity of the fibers contained within the composite. This fiber damage can negatively affect the tensile strength of the composite. By comparison, when non-metal oxide containing acid scavengers (e.g., calcium stearate, zinc stearate, hydrotalcite) are used, fiber damage is reduced or avoided altogether, thereby resulting in a thermoplastic composite that has an increased tensile strength when compared to the same composite that uses a metal oxide-based acid scavenger.

In one aspect of the present invention, a fiber-containing composite is described. The fiber containing composite can include (a) a thermoplastic polymer matrix, the thermoplastic polymer matrix comprising at least one non-metal oxide containing acid scavenger, and (b) fibers. In certain preferred instances, the fiber-containing composite does not include a metal oxide, preferably does not include zinc oxide, calcium oxide, or magnesium oxide, or any combination thereof or all thereof. In even more preferred instances, the composite does not include zinc oxide. The fiber-containing composite can have an increased tensile strength (e.g., 750 MPa or more, preferably 750 MPa to 1300 MPa) when compared to the same composite that includes a metal oxide containing acid scavenger (e.g., zinc oxide, calcium oxide, magnesium oxide, or mixtures thereof) rather than the non-metal oxide containing acid scavenger. For example, the tensile strength of the metal oxide containing composite can be less than 740 MPa. In some embodiments, the fiber-containing composite can have a thickness between approximately 0.1 to 0.5 mm, preferably 0.15 mm to 0.35 mm, or about 0.3 mm. In a preferred embodiment, the fiber-containing composite can be a unidirectional tape having the fibers dispersed in the polymeric matrix. Unidirectional tapes typically have the fibers substantially aligned in the same direction such as longitudinally positioned relative to the length of the tape. The fiber content in the fiber-containing composite can be 50 to 80 wt. %, preferably 60 to 75 wt. %, based on the total weight of the fiber-containing composite with the balance being the polymeric matrix. The non-metal oxide acid scavenger can include hydrotalcite, zinc stearate, calcium stearate, or mixtures thereof. In a preferred embodiment, the acid scavenger is hydrotalcite. The thermoplastic polymeric matrix can include a polyolefin (e.g., polypropylene and/or polyethylene), a polycarbonate, a polyamide, or copolymers thereof, or blends thereof. In some embodiments, thermoplastic polymeric matrix can include a polyolefin (e.g., polypropylene and/or polyethylene), a polycarbonate, a polyamide, or copolymers thereof, or blends thereof and the fibers are glass fibers. In some embodiments, the thermoplastic polymer matrix is polypropylene and/or polyethylene and the fibers are glass fibers. In other embodiments, the thermoplastic polymer is a polycarbonate or a polyamide or a blend thereof and the fibers are carbon fibers. The thermoplastic polymer matrix can also include one or more antioxidant compounds. In some embodiments, the thermoplastic polymer matrix can also include at least one of a light stabilizing compound, a heat stabilizing compound, and carbon black. In a preferred embodiment, the thermoplastic polymer matrix can include 80 wt. % to 90 wt. % of a polyolefin and 0.1 wt. % to 1 wt. % of an acid scavenger.

In another aspect of the invention, a fiber-containing composite can include (a) a polymer matrix and (b) 50 to 80 wt. % of glass fibers, based on the total weight of the fiber-containing composite. The polymeric matrix can includes up to 90 wt. % polypropylene, preferably 80 wt. % to 90 wt. % polypropylene, up to 1 wt. % of at least one of calcium stearate, preferably 0.1 wt. % to 1 wt. % calcium stearate, zinc stearate, or hydrotalcite, up to 3 wt. %, preferably 1 wt. % to 3 wt. % of a mixture of one or more antioxidants and a heat stabilizing compound or up to 4 wt. %, preferably 1 wt. % to 4 wt. % of a mixture of one or more antioxidants and a light stabilizing compound, and up to 5 wt. %, preferably 1 wt. % to 5 wt. % of a coupling agent. In some embodiments, the polymer matrix can include up to 3 wt. %, preferably 1 wt. % to 3 wt. % of carbon black.

In the context of the present invention 20 embodiments are described. Embodiment 1 is a fiber-containing composite, comprising: (a) a thermoplastic polymer matrix, the thermoplastic polymer matrix comprising at least one non-metal oxide containing acid scavenger; and (b) fibers, wherein the fiber-containing composite has an increased tensile strength when compared to the same composite that includes a metal oxide containing acid scavenger rather than the non-metal oxide containing acid scavenger. Embodiment 2 is the fiber-containing composite of embodiment 1, wherein the thermoplastic polymer matrix does not include a metal oxide, preferably zinc oxide, calcium oxide, magnesium oxide, or mixtures thereof, more preferably, zinc oxide. Embodiment 3 is the fiber-containing composite of any one of embodiments 1 to 2, wherein the acid scavenger comprises a metal stearate, a hydrotalcite, a metal carbonate, a metal hydroxide, or a mixture thereof. Embodiment 4 is the fiber-containing composite of embodiment 3, wherein the acid scavenger is calcium stearate, zinc stearate, a hydrotalcite, or a mixture thereof. Embodiment 5 is the fiber-containing composite of embodiment 4, wherein the acid scavenger is calcium stearate. Embodiment 6 is the fiber-containing composite of embodiment 4, wherein the acid scavenger is zinc stearate. Embodiment 7 is the fiber-containing composite of embodiment 4, wherein the acid scavenger is a hydrotalcite. Embodiment 8 is the fiber-containing composite of any one of embodiments 1 to 7, wherein the tensile strength is at least 750 MPa, preferably 750 MPa to 1300 MPa. Embodiment 9 is the fiber-containing composite of any one of embodiments 1 to 8, wherein the amount of fiber is 50 to 80 wt. %, preferably 60 to 75 wt. %, based on the total weight of the fiber-containing composite with the balance being the polymeric matrix. Embodiment 10 is the fiber-containing composite of any one of embodiments 1 to 9, wherein the thermoplastic polymer matrix comprises a polyolefin, a polycarbonate, a polyamide, or copolymers thereof, or blends thereof. Embodiment 11 is the fiber-containing composite of embodiment 10, wherein the fibers are glass fibers. Embodiment 12 is the fiber-containing composite of embodiment 10, wherein the thermoplastic polymer is a polycarbonate or a polyamide, or a blend thereof, and the fibers are carbon fibers. Embodiment 13 is the fiber-containing composite of any one of embodiments 1 to 12, wherein the thermoplastic polymer matrix further comprises one or more antioxidant compounds. Embodiment 14 is the fiber-containing composite of any one of embodiments 1 to 13, wherein the thermoplastic polymer matrix further comprises at least one of a light stabilizing compound, a heat stabilizing compound, carbon black, or mixtures thereof. Embodiment 15 is the fiber-containing composite of any one of embodiments 1 to 14, wherein the thermoplastic polymer matrix comprises: 80 wt. % to 90 wt. % of a polyolefin; and 0.1 wt. % to 1 wt. % of an acid scavenger. Embodiment 16 is the fiber-containing composite of any one of embodiments 1 to 15, having thickness between approximately 0.1 to 0.5 mm, preferably 0.15 mm to 0.35 mm, or about 0.3 mm. Embodiment 17 is the fiber-containing composite of embodiment 1, wherein: (a) the thermoplastic polymer matrix comprises polypropylene and 0.1 to 0.5 wt. % of the acid scavenger, wherein the acid scavenger comprises at least one of calcium stearate, zinc stearate, or hydrotalcite; and (b) the fibers comprise 50 to 80 wt. % of glass fibers, based on the total weight of the fiber-containing composite, and wherein the thermoplastic polymer matrix does not include a metal oxide, preferably zinc oxide, calcium oxide, magnesium oxide, or mixtures thereof, more preferably, zinc oxide. Embodiment 18 is the fiber-containing composite of any one of embodiments 1 to 17, wherein the fiber-containing composite is a unidirectional tape having the fibers dispersed in the polymeric matrix. Embodiment 19 is a fiber-containing composite comprising: (a) a thermoplastic polymer matrix comprising: (i) up to 90 wt. % polypropylene; (ii) up to 1 wt. % of at least one of calcium stearate, zinc stearate, or hydrotalcite; (iii) up to 3 wt. % of a mixture of one or more antioxidants and a heat stabilizing compound or up to 4 wt. % of a mixture of one or more antioxidants and a light stabilizing compound; and (iv) up to 5 wt. % of a coupling agent; and (b) 50 to 80 wt. % of glass fibers, based on the total weight of the fiber-containing composite, and wherein the thermoplastic polymer matrix does not include a metal oxide, preferably zinc oxide, calcium oxide, magnesium oxide, or mixtures thereof, more preferably, zinc oxide. Embodiment 20 is the fiber-containing composite of embodiment 19, further comprising up to 3 wt. % carbon black.

The following includes definitions of various terms and phrases used throughout this specification.

The term “unidirectional fibers” refers to substantially all of the fibers being substantially parallel to one another.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol.%”, or “mol.%” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The use of the phrase “up to” means that the composition includes the ingredient or material and excludes 0 wt. %, 0 mol.%, and 0 vol.%. For example, up to 0.1 wt. % includes an amount >0 wt. % to and including 0.1 wt. %.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The fiber-containing composites of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the thermoplastic fiber-containing composites of the present invention is that they include a non-metal oxide acid scavenger and have a tensile strength greater than a composite of the same composition that contains a metal oxide acid scavenger.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a statistical analyses of the tensile strength of unidirectional (UD) tapes of the present invention having glass fibers embedded in a polymeric matrix formulation that includes a polypropylene polymer, non-zinc oxide acid scavenger, antioxidants, carbon black, and a heat stabilizer, and the same UD tape but where the formulation includes zinc oxide as the acid scavenger instead of the non-zinc oxide acid scavenger.

FIG. 2 are micrographs of glass fibers after calcination of UD tape samples based on formulations of the present invention that include the non-zinc oxide acid scavenger and the comparative formulation that includes zinc oxide as the acid scavenger of FIG. 1.

FIG. 3 is a statistical analyses of the tensile strength of glass fiber based UD tapes based on formulations of the present invention that include a polypropylene polymer, non-zinc oxide acid scavenger, antioxidants, carbon black, and hindered amine light stabilizer and the same UD tape but where the formulation includes zinc oxide as the acid scavenger instead of the non-zinc oxide acid scavenger.

FIG. 4 are micrographs of glass fibers after calcination of unidirectional (UD) tape samples based on formulations of the present invention that include the non-zinc oxide acid scavenger (left and middle) and the comparative formulation that includes zinc oxide as the acid scavenger (right) of FIG. 3.

FIG. 5 is a statistical analyses of the tensile strength of glass fiber based UD tapes based on formulations of the present invention that include a polypropylene polymer, non-zinc oxide acid scavenger (hydrotalcite), antioxidants, and hindered amine light stabilizer, and the same UD tape but where the formulation includes zinc oxide as the acid scavenger instead of the non-zinc oxide acid scavengers.

FIG. 6 are micrographs of glass fibers after calcination of unidirectional (UD) tape samples based on formulations of the present invention that include the non-zinc oxide acid scavenger (left and middle) and the comparative formulation that includes zinc oxide as the acid scavenger (right) of FIG. 5.

While the invention is susceptible to various modifications and alternative forms, specific embodiments thereof are shown by way of example in the drawings. The drawings may not be to scale.

### DETAILED DESCRIPTION OF THE INVENTION

Many thermoplastic components have physical and mechanical requirements depending on the application. These requirements can be met by addition of additives.

However, the overall properties of the polymer, fibers, and/or fiber-containing composite can be affected by the additives or blends of additives, thus posing formulation challenges. A discovery has been found that addresses the problems associated with conventional reinforced thermoplastic components. The discovery is premised on a fiber-containing composite that can include a thermoplastic polymer (e.g., polypropylene or polyethylene) matrix that includes a non-metal oxide acid scavenger and fibers. The fiber-containing composite of the present invention can have a tensile strength greater than the same composite, but where a metal oxide acid scavenger is used rather than the non-metal oxide acid scavenger. In certain specific aspects, the tensile strength of the composites of the present invention can be at least 750 MPa.

A. Fiber-Containing Composite

Fiber-containing composites of the present disclosure can have a thermoplastic polymeric matrix and fibers. In some embodiments, the composite includes greater than or substantially equal to any one of, or between any two of 20, 25, 30, 35, 40, 45, and 50 wt. % of polymeric matrix, based on the total weight of the composite. In some embodiments, the composite includes greater than or substantially equal to any one of, or between any two of 50, 55, 60, 65, 70, 75, and 80 wt. % of fibers. In some embodiments, the fibers are dispersed in the polymeric matrix. The fibers can run the length of the fiber-containing composite. In some embodiments, the fibers can be substantially aligned in a single direction (e.g., unidirectional). More particularly, in the composite, the fibers can be aligned with either the length of composite or the width of the composite. The phrase, “aligned with” means within 10 degrees of parallel. For example, a unidirectional composite can include fibers aligned in a direction, where the smallest angle between the direction and a length of the composite can be greater than or substantially equal to any one of, or between any two of 0, 5, 10, 15, 20, 25, 30, 35, 40, 45, 50, 55, 60, 65, 70, 75, 80, 85, and 90 degrees. Notably, the fiber-containing composite has an increased tensile strength as compared to a composite with the same composition with zinc oxide used as an acid scavenger. The fiber-containing composite that includes a non-zinc oxide acid scavenger can have a tensile strength of at least 750 1MPa, or can be greater than or substantially equal to any one of, or between any two of 750 MPa, 775 MPa, 800 MPa, 825 MPa, 850 MPa, 875 MPa, 900 MPa, 950 MPa, 975 MPa, 1000 MPa, 1025 MPa, 1050 MPa, 1075 MPa, 1100 MPa, 1125 MPa, 1150 MPa, 1175 MPa, 1200 MPa, 1225 MPa, 1250 MPa, 1275 MPa, and 1300 MPa. Tensile strength can be measured using commercially available scientific instruments (for example, using a Shimadzu Autograph AGS-10kNX equipped with a 10 kN C 1 500 AGS-X load cell, (Shimadzu Corporation, Japan)).

1. Polymeric Matrix

The polymeric matrix can include a thermoplastic polymer or a blend of thermoplastic polymers. Non-limiting examples of thermoplastic polymers include polypropylene, a polycarbonate, a polyamide or a polyimide or blends thereof, or copolymers thereof. “Polypropylene” as used herein includes polypropylene and co-polymers thereof. “Polycarbonate polymers” as used herein include polycarbonate polymers and co-polymers thereof and are described in more detail below. “Polyimides” as used herein include polyimides and polyetherimides. In a preferred instance, the composite includes polypropylene, more specifically polypropylene homopolymer. Polypropylene can be obtained from various commercial suppliers. Non-limiting examples of commercial polypropylene include Achieve™ 6936G2 resin by ExxonMobil (U.S.A.), Braskem CP1220B by Songhan Plastic Technology Co., Ltd. (China), Moplen HP500V by LyondellBasell Industries Holding, B.V. (the Netherlands), PP FPC100 by SABIC® (Saudi Arabia), and the like. In some embodiments, the polypropylene can be a high flow polypropylene, which has a melt flow rate of 210 to 240 or about 230° C./2.16 Kg as determined by ISO 1133 at about 120 g/10 min). Polycarbonate polymers suitable for use in the present disclosure can have any suitable structure. For example, such a polycarbonate polymer can include a linear polycarbonate polymer, a branched polycarbonate polymer, a polyester carbonate polymer, or a combination thereof. Such a polycarbonate polymer can include a polycarbonate-polyorganosiloxane copolymer, a polycarbonate-based urethane resin, a polycarbonate polyurethane resin, or a combination thereof. The polycarbonate polymer can include an aromatic polycarbonate resin. For example, such aromatic polycarbonate resins can include the divalent residue of dihydric phenols bonded through a carbonate linkage and can be represented by the formula:

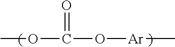

where Ar is a divalent aromatic group. The divalent aromatic group can be represented by the formula: —Ar₁—Y—Ar₂—, where Ar₁ and Ar₂ each represent a divalent carbocyclic or heterocyclic aromatic group having from 5 to 30 carbon atoms (or a substituent therefor) and Y represents a divalent alkane group having from 1 to 30 carbon atoms. For example, in some embodiments, —Ar₁—Y—Ar₂— is Ar₁—C(CH₃)—Ar₂, where Ar₁ and Ar₂ are the same. As used herein, “carbocyclic” means having, relating to, or characterized by a ring composed of carbon atoms. As used herein, “heterocyclic” means having, relating to, or characterized by a ring of atoms of more than one kind, such as, for example, a ring of atoms including a carbon atom and at least one atom that is not a carbon atom. “Heterocyclic aromatic groups” are aromatic groups having one or more ring nitrogen, oxygen, or sulfur atoms. In some embodiments, Ar₁ and Ar₂ can each be substituted with at least one substituent that does not affect the polymerization reaction. Such a substituent can include, for example, a halogen atom, an alkyl group having from 1 to 10 carbon atoms, an alkoxy group having from 1 to 10 carbon atoms, a phenyl group, a phenoxy group, a vinyl group, a cyano group, an ester group, an amide group, or a nitro group. Aromatic polycarbonate resins suitable for use in the present disclosure can be commercially available, such as, for example, Lexan® HF1110, available from SABIC Innovative Plastics (U.S.A.), or can be synthesized using any method known by those skilled in the art. Polycarbonate polymers for use in the present disclosure can have any suitable molecular weight; for example, an average molecular weight of such a polycarbonate polymer can be from approximately 5,000 to approximately 40,000 grams per mol (g/mol). Polyimides can be obtained from commercial suppliers such as RTP Co. (U.S.A.), DuPont™ (U.S.A.), or the like.

Non-limiting examples of acid scavengers suitable for use in the present invention include metal stearates, a hydrotalcite, a metal hydroxide, a metal carbonate, or mixtures thereof. The metal portion can be zinc or calcium. Metal stearates include zinc stearate and calcium stearate, which are available from various commercial vendors. Hydrotalcite can be an aluminum (Al), magnesium (Mg) hydroxide carbonate hydrate having the general formula of Mg_{4.3} to ₆Al₂CO₃(OH)_{12.6} to ₁₆·4(H₂O). Hydrotalcite and synthetic hydrotalcite are available from commercial vendors, for example Hycite® 713 is available from Clariant AG Corp. (Switzerland) and DHT-4A® from Kisuma Chemicals BV, (The Netherlands). A molar ratio of Mg/Al in the hydrotalcite can range from 3 to 5, 4 to 4.5, or 4.1 to 4.3. Naturally occurring hydrotalcite and synthetic hydrotalcite can be used interchangeably. In certain preferred instances, the polymeric matrix does not include a metal oxide, preferably does not include zinc oxide, calcium oxide, or magnesium oxide, or any combination thereof or all thereof. In even more preferred instances, the polymeric matrix does not include zinc oxide.

Coupling agents can include maleic anhydride grafted polyethylene, maleic anhydride grafted polypropylene, or a combination that includes at least one of the foregoing. Non-limiting examples of commercially available coupling agents include Polybond® 3150 maleic anhydride grafted polypropylene from Chemtura (U.S.A.), Fusabond® P613 maleic anhydride grafted polypropylene, from DuPont (U.S.A.), and Priex® 20097 maleic anhydride grafter polypropylene homopolymer from Addcomp (Germany). The polymeric matrix can include, based on the total weight of the polymeric matrix, 0.1 to 5 wt. % coupling agent or greater than or substantially equal to any one of, or between any two of 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, and 5.0 wt. % of coupling agent.

In some embodiments, the polymeric matrix includes additives such as carbon black, an antioxidant, a heat stabilizer, a hindered amine light stabilizer, a flow modifier, a flame retardant, an UV absorber, an impact modifier, a coupling agent, a colorant, etc., or any combinations thereof. An amount of additives range in the polymeric matrix can range from 0.01 to 10 wt. %, or be greater than or substantially equal to any one of, or between any two of 0.1, 0.5, 1, 1.5, 2, 2.5, 3, 3.5, 4, 4.5, 5, 5.5, 6, 6.5, 7, 7.5, 8, 8.5, 9, 9.5, and 10 wt. %.

The amount of carbon black in the polymeric matrix can range up to 3 wt. %, or be greater than or substantially equal to any one of, or between any two of 0.01, 0.1, 0.05, 0.5, 1, 1.25, 1.5, 1.75, 2, 2.25, 2.5, 2.75, and 3 wt. %. Carbon black can be obtained as a dispersion in a polymer (e.g., master batch carbon black). Carbon black master batches can be obtained from various commercial sources. An amount of carbon black in the master batch can range from 30 to 40% carbon black or any value there between. The polymeric matrix can include up to 5 wt. % of a carbon black master batch, be greater than or substantially equal to any one of, or between any two of 0.1, 0.5, 1, 1.5, 2, 2.5, 3, 3.5, 4, 4.5, and 5 wt. %.

Non-limiting examples of antioxidants include sterically hindered phenolic compounds, aromatic amines, a phosphite compound, carbon black and the like. Non-limiting examples of phenolic antioxidants include 2,6-di-tert-butyl-4-methylphenol (CAS No. 128-37-0), pentaerythritol-tetrakis(3-(3,5-di-tert-butyl-4-hydroxyphenyl)propionate (CAS No. 6683-19-8), octadecyl 3-(3′,5′-di-tert-butyl-4-hydroxyphenyl)propionate (CAS No. 2082-79-3), 1,3, 5-trimethyl-2,4,6-tris-(3, 5-di-tert-butyl-4-hydroxybenzyl)benzene (CAS No. 1709-70-2), 2,2′-thiodiethylenebis(3,5-di-tert-butyl-4-hydroxyphenyl)propionate (CAS No. 41484-35-9), calcium bis(ethyl 3,5-di-tert-butyl-4-hydroxybenzylphosphonate) (CAS No. 65140-91-2), 1,3, 5-tris(3′,5′-di-tert-butyl-4′-hydroxybenzyl)-isocyanurate (CAS No. 27676-62-6), 1,3,5-tris(4-tert-butyl-3-hydroxy-2,6-dimethylbenzyl)-1,3,5-triazine-2,4,6-(1H,3H, 5H)-trione (CAS No. 40601-76-1), 3,3-bis(3-tert-butyl-4-hydroxyphenyl)ethylene butyrate (CAS No. 32509-66-3), 4,4′-thiobis(2-tert-butyl-5-methylphenol) (CAS No. 96-69-5), 2,2′-methylene-bis-(6-(1-methyl-cyclohexyl)-para-cresol) (CAS No. 77-62-3), 3,3′-bis(3,5-di-tert-butyl-4-hydroxyphenyl)-N,N′-hexamethylenedipropionamide (CAS No. 23128-74-7), 2,5,7,8-tetramethyl-2-(4′,8′,12′-trimethyltridecyl)-chroman-6-ol (CAS No. 10191-41-0), 2,2-ethylidenebis(4,6-di-tert-butylphenol) (CAS No. 35958-30-6), 1,1,3-tris(2-methyl-4-hydroxy-5′-tert-butylphenyl)butane (CAS No. 1843-03-4), 3,9-bi s(1,1-dimethyl-2-(beta-(3-tert-butyl-4-hydroxy-5-methylphenyl)propionyloxy)ethyl)-2,4,8,10-tetraoxaspiro[5.5]undecane (CAS No. 90498-90-1;), 1,6-hexanediyl-bis(3,5-bis(1,1-dimethylethyl)-4-hydroxybenzene)propanoate) (CAS No. 35074-77-2), 2,6-di-tert-butyl-4-nonylphenol (CAS No. 4306-88-1), 4,4′-butylidenebis(6-tert-butyl-3-methylphenol (CAS No. 85-60-9); 2,2′-methylene bis(6-tert-butyl-4-methylphenol) (CAS No. 119-47-1), triethylenglyol-bis-(3-tert-butyl-4-hydroxy-5-methylphenyl)propionate (CAS No. 36443-68-2), a mixture of C₁₃ to C₁₅ linear and branched alkyl esters of 3-(3′,5′-di-tert-butyl-4′-hydroxyphenyl)propionic acid (CAS No. 171090-93-0), 2,2′-thiobis(6-tert-butyl-para-cresol) (CAS No. 90-66-4), diethyl-(3,5-di-tert-butyl-4-hydroxybenzyl)phosphate (CAS No. 976-56-7), 4,6-bis (octylthiomethyl)-ortho-cresol (CAS No. 110553-27-0), benzenepropanoic acid, octyl 3-(3,5-di-tert-butyl-4-hydroxyphenyl)propanoate (CAS No. 125643-61-0), 1,1,3-tris[2-methyl-4-[3-(3,5-di-tert-butyl-4-hydroxyphenyl)propionyloxy]-5-tert-butylphenyl]butane (CAS No. 180002-86-2), mixed styrenated phenols (CAS No. 61788-44-1), butylated, octylated phenols (CAS No. 68610-06-0), butylated reaction product of p-cresol and dicyclopentadiene (CAS No. 68610-51-5).

Non-limiting examples of phosphite antioxidant include one of tris(2,4-di-tert-butylphenyl)phosphite (CAS No. 31570-04-4, Irgafos® 168 (BASF)), tris(2,4-di-tert-butylphenyl)phosphate (CAS No. 95906-11-9), bis(2,4-di-tert-butylphenyl)pentaerythritol diphosphite (CAS No. 26741-53-7); and tetrakis (2,4-di-butylphenyl)-4,4′-biphenylene diphosphonite (CAS No. 119345-01-6), and bis (2,4-dicumylphenyl)pentaerythritol diphosphite (CAS No. 154862-43-8).

Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of hindered amine light stabilizers include dimethyl succinate polymer with 4-hydroxy-2,2,6,6-tetramethyl-1-piperidine ethanol (CAS No. 65447-77-0); poly[[6-((1,1,3,3-tetramethylbutyl)amino)-1,3,5-triazine2,4diyl][(2,2,6,6-tetramethyl-4-piperidyl)imino]hexamethylene[2,2,6,6-tetramethyl-4-piperidyl)imino]] (CAS No. 70624-18-9); and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane (CAS No. 106990-43-6).

Non-limiting examples of heat stabilizers include phenothiazine, p-methoxyphenol, cresol, benzhydrol, 2-methoxy-p-hydroquinone, 2,5-di-tert-butylquinone, diisopropylamine, and distearyl thiodipropionate (CAS No. 693-36-7). In a preferred embodiment, distearyl thiodipropionate which is sold under the trade name Irganox® PS 820 (BASF, Germany) is used.

In some embodiments, a mixture of at least two of 1,3,5-trimethyl-2,4,6-tris-(3,5-di-tert-butyl-4-hydroxybenzyl) benzene sold under the trade name of Irganox® 1330 (BASF, Germany), tris[2,4-bis(2-methyl-2-propanyl)phenyl]phosphite sold under the trade name of Irgafos® 168 (BASF, Germany), pentaerythritol-tetrakis (3-(3,5-di-tert-butyl-4-hydroxyphenyl) propionate sold under the trade name Irganox® 1010 (BASF, Germany), 1,5, 8,12-Tetrakis[4,6-bis(N-butyl-N-1,2,2,6,6-pentamethyl-4-piperidylamino)-1,3,5-triazin-2-yl]-1,5,8,12-tetraazadodecane sold under the trade name of Chimassorb 119 (BASF, Germany) is used.

Other additives can include stabilizers, UV absorbers, impact modifiers, cross-linking agents, processing aids, and fire-retardants. A non-limiting example of a stabilizer can include Irganox® B225, commercially available from BASF. In a still further aspect, neat polypropylene can be introduced as an optional additive. Non-limiting examples of flame retardants include halogen and non-halogen-based polymer modifications and additives that are free of zinc oxide, calcium oxide and magnesium oxide. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include elastomers/soft blocks dissolved in matrix-forming monomer(s), such as, for example, bulk HIPS, bulk ABS, reactor modified PP, Lomod, Lexan EXL, and/or the like, thermoplastic elastomers dispersed in matrix material by compounding, such as, for example, di-, tri-, and multiblock copolymers, (functionalized) olefin (co)polymers, and/or the like, pre-defined core-shell (substrate-graft) particles distributed in matrix material by compounding, such as, for example, MBS, ABS-HRG, AA, ASA-XTW, SWIM, and/or the like, or combinations thereof. Non-limiting examples of cross-linking agents include divinylbenzene, benzoyl peroxide, alkylenediol di(meth)acrylates, such as, for example, glycol bisacrylate and/or the like, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, or combinations thereof. Non-limiting examples of fire-retardant additives include nitrogen-phosphorus compounds, phosphoric acid, organo-phosphorus compounds, nitrogen-containing polymers, talc, sulfonates or salts thereof, halogen-containing compounds, silica, hydrated oxides, organic polymers, nanoclays, organoclay, organic polymers, silicon-phosphorous-nitrogen compounds, and mixtures thereof. Non-limiting examples of nitrogen-phosphorus fire-retardant compounds include a nitrogen-containing phosphate, a nitrogen-containing polyphosphate, ammonium phosphate, ammonium pyrophosphate, piperazine pyrophosphate, piperazine polyphosphate, melamine pyrophosphate, or a combination thereof. The term “phosphate” refers to a salt or ester of a phosphoric acid. The term “pyrophosphate” refers to phosphate PO₄ structural units linked together by an oxygen atom. The term “polyphosphate” refers to a salt or ester of a polymeric oxyanion formed from three of more phosphate (PO₄) structural units linked together by sharing oxygen atoms. Nitrogen-phosphorus fire-retardant compounds and/or compositions are described in U.S. Pat. No. 7,803,856 to Perego et al., and U.S. Patent Application Publ. No. 2013/0248783 to Zhu et al., or can be obtained from commercial sources such as Adeka Palmarole (Japan) under the tradenames ADK STAB FP-2100JC, ADK STAB FP-2200S and ADK STAB FP-2500S. Non-limiting examples of nitrogen-containing polymers include poly(2,4-piperazinyl-6-morpholinyl-1,3,5-triazine), poly(2,4-piperazinyl-6-morpholinyl-1,3,5-triazine). Non-limiting examples, of phosphorus fire-retardants includes resorcinol bis(diphenyl phosphate), bisphenol A bis(diphenyl phosphate), triphenyl phosphate, tricresyl phosphate, phosphoric acid derivatives, and the like. The total amount of fire-retardant composition in the polymeric matrix can be 4 to 10 wt. %, or greater than or substantially equal to any one of, or between any two of: 4, 4.5, 5, 5.5, 6, 6.5, 7, 7.5, 8, 8.5, 9, 9.5, or 10 wt. %. Processing aids can be used to help process the polymeric composition. A non-limiting example of a processing aid is a blend of anionic and ionic surfactants sold under the trade name STRUCKTOL® TR 251 by Struktol Company of America (USA).

In some embodiments, a master batch of the additives and the non-metal acid scavenger can be used. A master batch can include 15 to 20 wt. % of Irganox® 1010, 5 to 10 wt. % Irgafos® 168, 5 to 10 wt. % Chimaasorb 119 and 5 to 10 wt. % of the non-metal acid scavenger (e.g., DHT 4A, and/or Hycite 713), and optional 10 to 20 wt. % of a process aid (e.g. Struktol TR 2510). All or a portion of the master batch can be added to the polymeric matrix during processing. For example 35 to 45 wt. % of the master batch can be added to 55 to 65 wt. % of the polymeric matrix. In another example, 10 to 20 wt. % of the master batch can be added to 80 to 90 wt. % of the polymer.

In some embodiments, a first formulation of a polymeric matrix can include 80 to 90 wt. % (e.g., greater than, equal to, or between any two of 80, 81, 82, 83, 84, 85, 86, 87, 88, 89, and 90 wt. %) of the polymer (e.g., polypropylene), 4 to 5 wt. % (e.g., greater than, equal to, or between any two of 4, 4.1, 4.2, 4.3, 4.4, 4.5, 4.6, 4.7, 4.8, 4.9, and 5 wt. %) of the coupling agent, 4 to 5 wt. % (e.g., greater than, equal to, or between any two of 4, 4.1, 4.2, 4.3, 4.4, 4.5, 4.6, 4.8, 4.9, and 5 wt. %) of master batch carbon black, 1 to 2 wt. % (e.g., greater than, equal to, or between any two of 1, 1.1, 1.2, 1.3, 1.4, 1.5, 1.6, 1.7, 1.8, 1.9, and 2 wt. %) heat stabilizer (e.g. Irganox® PS 802), and 2.0 to 3.0 wt. % (e.g., greater than, equal to, or between any two of 2, 2.1, 2.2, 2.3, 2.4, 2.5, 2.6, 2.7, 2.8, 2.9, and 3 wt. %) of a mixture of antioxidants (e.g., 1 to 2 wt. % Irganox® 1330 (e.g., greater than, equal to, or between any two of 1, 1.1, 1.2, 1.3, 1.4, 1.5, 1.6, 1.7, 1.8, 1.9, and 2 wt. %), 0.4 to 0.5 wt. % of Irganox® 1010 (e.g., greater than, equal to, or between any two of 0.4, 0.41, 0.42, 0.43, 0.44, 0.45, 0.46, 0.47, 0.48, 0.49, and 0.5 wt. %), and 0.4 to 0.5 wt. % of Irgafos® 168 (e.g., greater than, equal to, or between any two of 0.4, 0.41, 0.42, 0.43, 0.44, 0.45, 0.46, 0.47, 0.48, 0.49, and 0.5 wt. %), in combination with 0.4 to 0.5 wt. % (e.g., greater than, equal to, or between any two of 0.4, 0.41, 0.42, 0.43, 0.44, 0.45, 0.46, 0.47, 0.48, 0.49, and 0.5 wt. %) of zinc stearate. A second formulation can include the ingredients of the first formulation except that 0.4 to 0.5 wt. % (e.g., greater than, equal to, or between any two of 0.4, 0.41, 0.42, 0.43, 0.44, 0.45, 0.46, 0.47, 0.48, 0.49, and 0.5 wt. %) of calcium stearate is used instead of zinc stearate. A third formulation can include the ingredients of the first formulation except that 0.4 to 0.5 wt. % (e.g., greater than, equal to, or between any two of 0.4, 0.41, 0.42, 0.43, 0.44, 0.45, 0.46, 0.47, 0.48, 0.49, and 0.5 wt. %) of hydrotalcite is used instead of zinc stearate. Formulations 1-3 (e.g., 20 wt. % to 50 wt. %) can be combined with 50 wt. % to 80 wt. % fibers (e.g., glass fibers) to form the fiber-containing composite of the present invention.

In some embodiments, a fourth polymer matrix formulation can include 80 to 90 wt. % (e.g., greater than, equal to, or between any two of 80, 81, 82, 83, 84, 85, 86, 87, 88, 89, and 90 wt. %) of the polymer (e.g., polypropylene), 4 to 5 wt. % (e.g., greater than, equal to, or between any two of 4, 4.1, 4.2, 4.3, 4.4, 4.5, 4.6, 4.7, 4.8, 4.9, and 5 wt. %) of the coupling agent, 4 to 5 wt. % (e.g., greater than, equal to, or between any two of 4, 4.1, 4.2, 4.3, 4.4, 4.5, 4.6, 4.8, 4.9, and 5 wt. %) of master batch carbon black, 2.0 to 3.0 wt. % (e.g., greater than, equal to, or between any two of 2, 2.1, 2.2, 2.3, 2.4, 2.5, 2.6, 2.7, 2.8, 2.9, and 3 wt. %) of a mixture of antioxidants (e.g., 1 to 2 wt. % Irganox® 1010 (e.g., greater than, equal to, or between any two of 1, 1.1, 1.2, 1.3, 1.4, 1.5, 1.6, 1.7, 1.8, 1.9, and 2 wt. %), and 0.5 to 1.1 wt. % of Irgafos® 168 (e.g., greater than, equal to, or between any two of 0.5, 0.51, 0.55, 0.60, 0.65, 0.70, 0.75, 0.80, 0.85, 0.90, 0.95, 1.0, and 1.1 wt. %), and 0.5 to 1.0 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of a light stabilizing compound in combination with 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of zinc stearate. A fifth formulation can include the ingredients of the fourth formulation except that 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of calcium stearate is used instead of zinc stearate. A sixth formulation can include the ingredients of the fourth formulation except that 0.5 or 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of hydrotalcite is used instead of zinc stearate. Formulations 4-6 (e.g., 20 wt. % to 50 wt. %) can be combined with 50 wt. % to 80 wt. % fibers (e.g., glass fibers) to form the fiber-containing composite of the present invention.

In some embodiments, a seventh polymeric matrix formulation can include 80 to 90 wt. % (e.g., greater than, equal to, or between any two of 80, 81, 82, 83, 84, 85, 86, 87, 88, 89, and 90 wt. %) of the polymer (e.g., polypropylene), 4 to 5 wt. % (e.g., greater than, equal to, or between any two of 4, 4.1, 4.2, 4.3, 4.4, 4.5, 4.6, 4.7, 4.8, 4.9, and 5 wt. %) of the coupling agent, 2.0 to 3.0 wt. % (e.g., greater than, equal to, or between any two of 2, 2.1, 2.2, 2.3, 2.4, 2.5, 2.6, 2.7, 2.8, 2.9, and 3 wt. %) of a mixture of antioxidants (e.g., 1 to 2 wt. % Irganox® 1010 (e.g., greater than, equal to, or between any two of 1, 1.1, 1.2, 1.3, 1.4, 1.5, 1.6, 1.7, 1.8, 1.9, and 2 wt. %), and 0.5 to 1.1 wt. % of Irgafos® 168 (e.g., greater than, equal to, or between any two of 0.5, 0.51, 0.55, 0.60, 0.65, 0.70, 0.75, 0.80, 0.85, 0.90, 0.95, 1.0, and 1.1 wt. %), and 0.5 to 1.0 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of a light stabilizing compound in combination with 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of zinc stearate. An eighth formulation can include the ingredients of the seventh formulation except that 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of calcium stearate is used instead of zinc stearate. A ninth formulation can include the ingredients of the seventh formulation except that 0.5 to 1 wt. % (e.g., greater than, equal to, or between any two of 0.5, 0.51, 0.55, 0.60, 0.65, 0.70, 0.75, 0.80, 0.85, 0.90, 0.95, and 1.0 wt. %) of hydrotalcite instead of zinc stearate. Formulations 7-9 (e.g., 20 wt. % to 50 wt. %) can be combined with 50 wt. % to 80 wt. % fibers (e.g., glass fibers) to form the fiber-containing composite of the present invention.

2. Fibers

Non-limiting examples of fibers include glass fibers, carbon fibers, aramid fibers, polyethylene fibers, polyester fibers, polyamide fibers, ceramic fibers, basalt fibers, steel fibers, and/or the like. The fiber-containing composite can include, based on the total weight of the composite, 50 to 80 wt. % fibers or greater than or substantially equal to any one of, or between any two of: 50, 55, 60, 65, 70, 75, 80 wt. % fibers. Fibers of a composite can be provided in bundles (e.g., bundles of carbon, ceramic, carbon precursor, ceramic precursor, glass, and/or the like fibers). Such bundles may include any number of fibers, such as, for example, 400, 750, 800, 1,375, 1,000, 1,500, 3,000, 6,000, 12,000, 24,000, 50,000, 60,000, or more fibers. Fibers in a bundle can have an average filament diameter of 5, 6, 7, 8, 9, 10, 11, 12, 13, 14, 15, 16, 17, 18, 19, 20, 21, 22, 23, 24, 25, or more microns (e.g., from 5 to 30 microns, 10 to 20 microns, 12 to 15 microns, or any range there between). The fibers can be long (e.g., have a high aspect ratio). Aspect ratios can be from 2 to 10 or 10 to 500, or any value there between. Fibers can be provided with a coating (e.g. a coating of an organic polymer, such as an organosilane), a pigment, and/or the like. Fibers can also be provided as a woven mat. In a preferred embodiment, the fibers are glass fibers when polyolefin polymers are used. In another preferred embodiment, the fibers are carbon fibers when polycarbonates or polyimides are used in the polymeric matrix.

C. Process to Prepare Fiber-Containing Composites

Fiber-containing composites of the present invention can be made by dispersing fibers in a polymer matrix as described in International Application Publication No. WO 2016/142786 to Prins et al., which is incorporated by reference in its entirety. In such a method, a sheet or film that includes thermoplastic polymer matrix and additive can be supplied between a first and a second spreaded fiber layers. Heat can be applied to the fiber layer/polymer composition/fiber layer material, followed by pressing the fiber layers into the polymer composition. In some embodiments, after pressing is completed, the first or second fiber layers can be rubbed. In some embodiments, the fibers are not spread prior to heating. In another embodiment, the fiber-containing composite can be made by using known impregnation techniques. For example, Miller et al. in Polymers & Polymer Composites, 1996, Vol. 4, No. 7 describes impregnation techniques for thermoplastic matrix composites, which is incorporated by reference in its entirety. One such method can include providing supplying fibers to one or more solution baths (e.g., thermoplastic polymer in one or two baths) to form resin impregnated fibers, drying the fibers, and then pressing the fibers to produce a fiber-containing composite (e.g., prepreg sheets). In another embodiment, the polymer and fibers can be stacked together, heated, and then pressed causing the resin to flow transverse to the fibers to from prepreg sheets of fiber-containing composites. In a preferred embodiment, the fiber-containing composite is a unidirectional tape.

Also disclosed are laminates including fiber-containing composites of the present disclosure. Such laminates can include 2, 3, 4, 5, 6, 7, 8, 9, 10, or more plies where at least one ply is a fiber-containing composite of the present disclosure. In some laminates, at least two plies are positioned such that their respective fibers are substantially parallel to a first axis. In some laminates, at least two plies are positioned such that their respective fibers are not parallel to each other. Fiber-containing composites and laminates of the present disclosure can be assembled or processed into two-dimensional or three-dimensional structures, such as, for example, via winding and/or lay-up techniques.

D. Articles of Manufacture

Article of manufacture can includes any of the fiber-containing composites of the present disclosure or laminates made therefrom. Non-limiting examples of such articles of manufacture include automotive parts (e.g., doors, hoods, bumpers, A-beams, B-beams, battery casings, bodies in white, reinforcements, cross beams, seat structures, suspension components, hoses, and/or the like), braided structures, woven structures, filament wound structures (e.g., pipes, pressure vessels, and/or the like), aircraft parts (e.g., wings, bodies, tails, stabilizers, and/or the like), wind turbine blades, boat hulls, boat decks, transportation components, rail cars, rail car parts, sporting goods, window lineals, pilings, docks, reinforced wood beams, retrofitted concrete structures, reinforced extrusion or injection moldings, hard disk drive (HDD) or solid state drive (SSD) casings, TV frames, smartphone mid-frames, smartphone unibody casings, tablet mid-frames, tablet unibody casings, TV stands or tables, lap-top computer casings, ropes, cables, protective apparel (e.g., cut-resistant gloves, helmets, and/or the like), armor, plates, and the like. Non-limiting examples of transportation components can include floor panels, claddings, covers, and tray tables for train interiors. Non-limiting examples of claddings include: interior vertical surfaces, such as side walls, front walls, end-walls, partitions, room dividers, flaps, boxes, hoods and louvres; interior doors and linings for internal and external doors; window insulations; kitchen interior surfaces; interior horizontal surfaces, such as ceiling paneling, flaps, boxes, hoods and louvres; luggage storage areas, such as overhead and vertical luggage racks, luggage containers and compartments; driver's desk applications, such as paneling and surfaces of driver's desk; interior surfaces of gangways, such as interior sides of gangway membranes (bellows) and interior linings; window frames (including sealants and gaskets); (folding) tables with downward facing surface; interior and exterior surface of air ducts, and devices for passenger information (such as information display screens) and the like.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

General Procedures and Testing

Unidirectional tapes were made using the process described in International Patent Application Publication. WO 2016142786 to Prins et al., which is incorporated herein by reference. The resulting failure load was measured using a Shimadzu Autograph AGS-10 kNX equipped with a 10 kN C 1 500 AGS-X load cell (Shimadzu Corporation, Japan). Samples were clamped using the TH154-BD vice grips using diamond coated jaws from Grip-Engineering Thümler GmbH (Germany) unless otherwise indicated, and loaded up to failure with a speed of 10 m/min. The tensile strength was then calculated by dividing the failure load (the maximum force recorded during the test) by the averaged sample thickness and width.

### Example 1

### Fiber-Containing Composite—Reference Sample

A unidirectional tape with a glass fiber weight fraction of 69.45%, thickness of 0.254 mm was made using the general method above and the matrix formulation listed in Table 1. The tensile strength was measures as described in the general procedures and testing. The tape had an average tensile strength of 981 MPa.

TABLE 1

| Constituent | Wt.% |
|---|---|
| Polypropylene homopolymer (hPP) | 92.59% |
| Coupling agent | 3.7% |
| Master batch Carbon Black | 3.7% |

### Example 2

### Fiber-Containing Composite with Acid Scavengers of the Present Invention and Comparative Zinc Oxide

Unidirectional (UD) tapes were made using the general procedure and the formulations given in Table 2 in combination with glass fibers to determine the effect of non-metal acid scavengers of the present invention, namely, hydrotalcite (DHT-4A®, Hycite® 713), zinc stearate (ZnSt) and calcium stearate (CaSt), and a metal-oxide acid scavenger, namely ZnO on the tensile strength. The resulting UD tapes had an averaged thickness of 0.276 mm and a fiber weight fraction of 68.26%. The master batch of carbon black had a 38 wt. % carbon black content.

TABLE 2

| | Formu- | Formu- | Formu- | Formu- | Formu- |
|---|---|---|---|---|---|
| | lation | lation | lation | lation | lation |
| | 11 | 12 | 13 | 14 | 15 |
| Constituent | Wt. % | | | | |
| hPP | 86.05% | | | | |
| Coupling agent | 4.67% | | | | |
| Master batch | 4.90% | | | | |
| Carbon Black | | | | | |
| PS802 | 1.47% | | | | |
| Irganox ® 1330 | 1.47% | | | | |
| Irgafos ® 168 | 0.48% | | | | |
| Irganox ® 1010 | 0.48% | | | | |
| DHT-4A ® | 0.48% | | | | |
| Zn stearate | — | 0.48% | | | |
| Ca stearate | — | | 0.48% | | |
| Hycite ® 713 | — | | | 0.48% | |
| ZnO | — | | | | 0.48% |

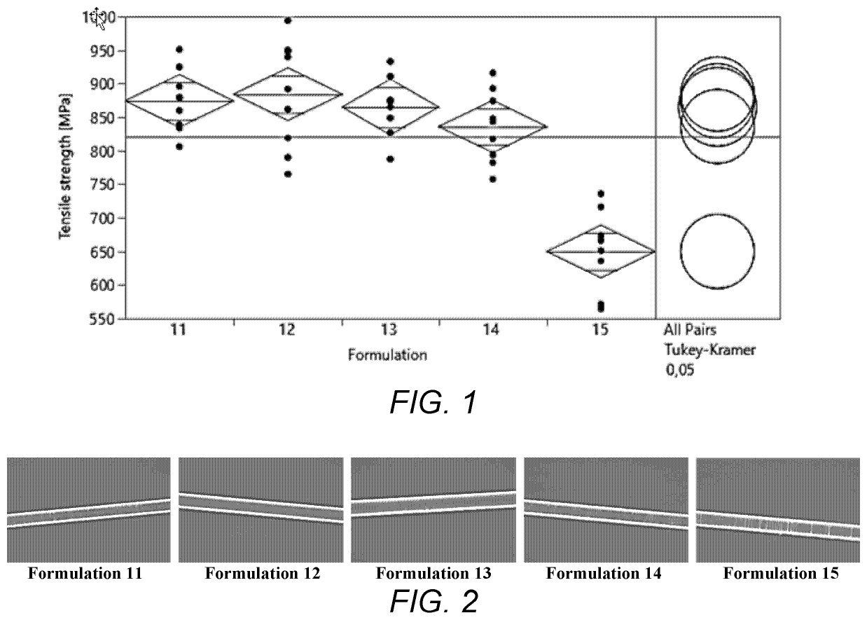

The resulting tensile strength is graphically given FIG. 1 and was analyzed using JMP® 12.0.1 from SAS (U.S.A.). From analyses of the data, it was determined that the data of each group were normally distributed. There was a significant difference between the tensile strength of Formulation 15 (zinc oxide acid scavenger) and the tensile strength of acid scavengers of the present invention formulations (using the Tukey-Kramer method).

### Example 3

### Microscopy and calcination of Example 2 Samples

The UD tapes from Example 2 were calcined at 675° C. for 30 minutes in an UMEGA-Snol 22/1100 LHM21S muffle furnace to remove the polymer from the glass fibers. After calcination, the samples were allowed to cool down and the remaining fibers were optically investigated with a Trinocular Oxion OX.3245 microscope from Euromex (The Netherlands) equipped with semi-apochromatic 50x objective and micrographs were taken using a CMEX 5 CMOS camera using polarizers. FIG. 2 depicts micrographs of fibers after calcination for (from left to right) Formulation 11 of the present invention, Formulation 12 of the present invention, Formulation 13 of the present invention, Formulation 14 of the present invention and Formulation 15, zinc oxide sample. In the Formulation 15 fiber micrograph, illuminating lines perpendicular to the fibers length direction were observed, which were not visible in the Formulation 12, 13, and 14 fiber micrographs. In the Formulation 11 fiber micrographs some of illuminating lines perpendicular to the fibers length direction. However, these lines were significantly less than those of Formulation 15. Without wishing to be bound by theory, it is believed that these illuminating lines are scratches on the glass, which increase the defect level of the glass fiber. Based on the data from FIG. 1 and FIG. 2, it was concluded that ZnO has a negative impact on the tensile strength of a UD tape.

### Example 4

### Fiber-Containing Composite with Acid Scavengers of the Present Invention and Comparative Zinc Oxide

UD tapes were made using the general procedure with glass fibers and a polymer matrix formulation that included hindered amine light stabilizer, antioxidants, carbon black and hydrotalcite (DHT-4A®, Hycite ® 713) acid scavengers of the present invention. A comparative sample using the same ingredients except ZnO was substituted for the hydrotalcite. Table 3 lists the formulations. Formulations 21 and 22 include hydrotalcites and Formulation 23 included zinc oxide. The resulting tapes had an averaged thickness of 0.244 mm and a fiber weight fraction of 70.13%.

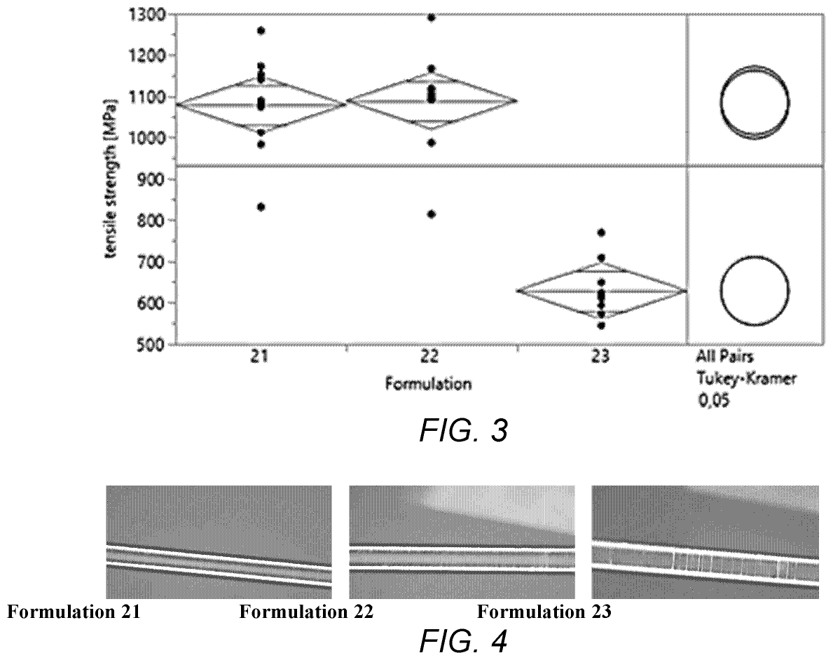

The resulting tensile strength of Formulations 21, 22 and 23 is graphically given FIG. 3 and analyzed using JMP® 12.0.1 from SAS. The samples were clamped using the TH222-40-80 grips from Grip-Engineering Thümler GmbH (Germany). From the analyses, it was determined that the data of each group are normally distributed and that there was a significant difference between the tensile strength of the formulation containing a metal oxide (zinc oxide of Formulation 23) and the tensile strength of the other formulations that included hydrotalcite (using the Tukey-Kramer method). Formulations 21 and 22 of the present invention showed no significant difference from each other.

TABLE 3

| | Formu- | Formu- | Formu- |
|---|---|---|---|
| | lation | lation | lation |
| | 21 | 22 | 23 |
| Constituent | Wt. % | | |
| hPP | 86.05% | | |
| Coupling agent | 4.67% | | |
| Master batch Carbon Black | 4.90% | | |
| Irganox ® 1010 | 1.94% | | |
| Irgafos ® 168 | 0.97% | | |
| Chimassorb 119 | 0.77% | | |
| DHT4A ® | 0.70% | — | — |
| Hycite ® 713 | — | 0.70% | — |
| ZnO | — | — | 0.70% |

### Example 5

### Microscopy and calcination of Example 4 Samples

The UD tapes from Example 4 were calcined and analyzed as described in Example 3. FIG. 4 depicts micrographs of fibers after calcination for Formulation 21 (left) of the present invention, Formulation 22 (middle) of the present invention and Formulation 23 (right), zinc oxide sample. In the Formulation 23 fiber micrograph, illuminating lines perpendicular to the fibers length direction were observed, which were not visible in the Formulation 22 fiber micrographs. In the Formulation 21 fiber micrographs some of illuminating lines perpendicular to the fibers length direction. However, these lines were significantly less than those of Formulation 23. Based on the data from FIG. 3 and FIG. 4, it was concluded that ZnO has a negative impact on the tensile strength of a UD tape.

### Example 6

### Fiber-Containing Composite with Acid Scavengers of the Present Invention absent Carbon Black and Comparative Zinc Oxide

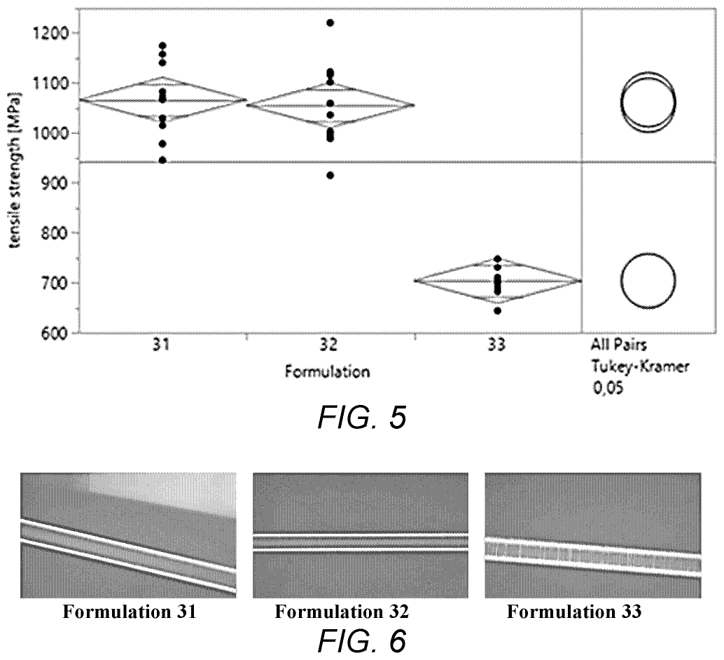

UD tapes were made using the general procedure with glass fibers and the polymer matrix formulation listed in Table 4. These samples are the same as Example 4, but did not include carbon black. Formulation 31 and 32 include formulations of the present invention and Formulation 33 is the comparative zinc oxide sample. The resulting tapes had an averaged thickness of 0.253 mm and a fiber weight fraction of 68.84 wt. %. FIG. 5 depicts graphical plots of the resulting tensile strength analyzed using JMP® 12.0.1 from SAS of Formulations 31, 32 and 33. The samples were clamped using the TH222-40-80 grips from Grip-Engineering Thümler GmbH. From the analyses, it was determined that the data of each group are normally distributed and that there was a significant difference between the tensile strength of zinc oxide Formulation 33 and the tensile strength of Formulations 31 and 32 of the present invention (using the Tukey-Kramer method). Formulations 31 and 32 showed no significant difference from each other.

TABLE 4

| | Formu- | Formu- | Formu- |
|---|---|---|---|
| | lation | lation | lation |
| | 31 | 32 | 33 |
| Constituent | Wt. % | | |
| hPP | 90.95% | | |
| Coupling agent | 4.67% | | |
| Irganox ® 1010 | 1.94% | | |
| Irgafos ® 168 | 0.97% | | |
| Chimassorb 119 | 0.78% | | |
| DHT4A ® | 0.70% | — | — |
| Hycite ® 713 | — | 0.70% | — |
| ZnO | — | — | 0.70% |

### Example 7

### Microscopy and calcination of Example 6 Samples

The UD tapes from Example 6 were calcined and analyzed as described in Example 3. FIG. 6 depicts micrographs of fibers after calcination for Formulation 31 (left) of the present invention, Formulation 32 (middle) of the present invention and Formulation 33 (right), zinc oxide sample. In the Formulation 33 fiber micrograph, illuminating lines perpendicular to the fibers length direction were observed, which were not visible in the Formulation 32 fiber micrographs. In the Formulation 31 fiber micrographs some of illuminating lines perpendicular to the fibers length direction. However, these lines were significantly less than those of Formulation 33. Based on the data from FIG. 5 and FIG. 6, it was concluded that ZnO has a negative impact on the tensile strength of a UD tape.

1. A fiber-containing composite, comprising:
(a) a thermoplastic polymer matrix, the thermoplastic polymer matrix comprising a polyolefin, a polycarbonate, a polyamide, or copolymers thereof, or blends thereof, and at least one non-metal oxide containing acid scavenger; and
(b) fibers,
wherein the fiber-containing composite has an increased tensile strength when compared to the same composite that includes a metal oxide containing acid scavenger rather than the non-metal oxide containing acid scavenger, wherein the acid scavenger comprises a metal stearate, a hydrotalcite, a metal carbonate, a metal hydroxide, or a mixture thereof;
wherein the fiber-containing composite has a thickness between approximately 0.1 to 0.5 mm,
wherein the amount of fiber is 50 to 80 wt. %,
wherein the thermoplastic polymer matrix does not include a metal oxide;
wherein the fiber-containing composite is a unidirectional tape having the fibers dispersed in the polymeric matrix; and
wherein the tensile strength is 750 MPa to 1300 MPa.

2. The fiber-containing composite of claim 1, wherein the acid scavenger is a metal hydroxide.

3. The fiber-containing composite of claim 1, wherein the acid scavenger a metal carbonate.

4. The fiber-containing composite of claim 1, wherein the acid scavenger is a metal carbonate, a metal hydroxide, or a mixture thereof.

5. The fiber-containing composite of claim 1, wherein the fibers are carbon fibers.

6. The fiber-containing composite of claim 1, wherein the acid scavenger is zinc stearate.

7. The fiber-containing composite of claim 1, wherein the acid scavenger is a hydrotalcite.

8. The fiber-containing composite of claim 1, wherein the tensile strength is 1300 MPa.

9. The fiber-containing composite of claim 1, wherein the amount of fiber is 60 to 75 wt. %, based on the total weight of the fiber-containing composite with the balance being the polymeric matrix.

10. The fiber-containing composite of claim 1, wherein the thermoplastic polymer matrix comprises polypropylene homopolymer.

11. The fiber-containing composite of claim 10, wherein the fibers are glass fibers.

12. The fiber-containing composite of claim 10, wherein the fibers are carbon fibers.

13. The fiber-containing composite of claim 1, wherein the thermoplastic polymer matrix further comprises one or more antioxidant compounds.

14. The fiber-containing composite of claim 1, wherein the thermoplastic polymer matrix further comprises a light stabilizing compound.

15. The fiber-containing composite of claim 1, wherein the thermoplastic polymer matrix comprises:
80 wt. % to 90 wt. % of a polyolefin; and
0.1 wt. % to 1 wt. % of an acid scavenger.

16. The fiber-containing composite of claim 1, having thickness between approximately 0.15 mm to 0.35 mm.

17. The fiber-containing composite of claim 1, wherein:
(a) the thermoplastic polymer matrix comprises polypropylene and 0.1 to 0.5 wt. % of the acid scavenger, wherein the acid scavenger comprises at least one of calcium stearate, zinc stearate, or hydrotalcite; and
(b) the fibers comprise 50 to 80 wt. % of glass fibers, based on the total weight of the fiber-containing composite.

18. The fiber-containing composite of claim 2, wherein the thermoplastic polymer matrix further comprises a light stabilizing compound.

19. A fiber-containing composite comprising:
(a) a thermoplastic polymer matrix comprising:
up to 90 wt. % polypropylene;
(ii) up to 1 wt. % of at least one of calcium stearate, zinc stearate, or hydrotalcite;
(iii) up to 3 wt. % of a mixture of one or more antioxidants and a heat stabilizing compound or up to 4 wt. % of a mixture of one or more antioxidants and a light stabilizing compound; and
(iv) up to 5 wt. % of a coupling agent; and
(b) 50 to 80 wt. % of glass fibers, based on the total weight of the fiber-containing composite,
wherein the thermoplastic polymer matrix does not include a metal oxide; and
wherein the fiber-containing composite has a thickness between approximately 0.1 to 0.5 mm.

20. The fiber-containing composite of claim 1, further comprising a coupling agent selected from the group consisting of maleic anhydride grafted polyethylene and maleic anhydride grafted polypropylene, or a combination thereof.
